(19) United States
(12) Patent Application Publication
(10) Pub. No.: US 2003/0177306 A1
(43) Pub. Date: Sep. 18, 2003

(54) Track level snapshot

(76) Inventors: Robert Alan Cochran, Roseville, CA (US); David E. Oseto, Newcastle, CA (US); Harald Burose, Herrenberg (DE)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/096,936

(22) Filed: Mar. 14, 2002

(51) Int. Cl. G06F 12/00

(52) U.S. Cl. 711/114; 711/154; 711/162

(57) ABSTRACT

An apparatus, method, computer readable medium and logical device have been created for storing essentially only modified or changed information from one of a pair of mirrored storage devices. In one exemplary embodiment, essentially only tracks of information from a primary volume of a mirrored pair of mirrored storage units, which have been modified since creation of the mirror, need be stored. In another exemplary embodiment, essentially only tracks of information from a primary volume of a mirrored pair of mirrored storage units, which have been modified since a last resynchronization, need be stored. In yet another exemplary embodiment, essentially only tracks of information from a primary volume of a mirrored pair of mirrored storage units, which have been modified since a last command, need be stored. By storing actual information which was modified and by storing essentially only information which was modified, a small amount of actual information need be stored. In addition, such information can be stored on the same storage unit as, or on a storage unit separate from, one or more of the primary and secondary volumes. As such, recovery of information can occur quickly. Only necessary information need be recovered; recovery can occur quickly; and/or recovery can occur in either a forward or backward direction.

### FIELD OF THE INVENTION

This invention generally relates to a storage device and a method for maintaining storage devices, and more preferably relates to maintaining storage device pairs.

### BACKGROUND OF THE INVENTION

Physical disk space on storage devices, such as disk drives or disk arrays (grouped disk drives), is typically mapped to logical units of storage. The disk space is typically identified in tracks, wherein these tracks can be sequentially numbered to identify the tracks. Logical mapping can extend in many hierarchical levels. The smallest units can be grouped into logical volumes. Logical volumes can then be grouped further into volume groups, etc.

Application software references storage space on storage devices, such as disks drives and/or disk arrays, through these logical mappings. For high availability purposes, host based or storage device based mirroring software is typically used to create a duplicate copy of a volume group of a storage device, on the same or on a remote storage device such as a disk drive or disk array for example. The local or primary volume and the remote or secondary volume pair is often referred to as a storage device pair or disk volume pair.

Array-based mirroring software provides functionality to create, split, delete, and check the status of a disk pair. During the mirroring process, the primary volume is directly writable by an application, and the secondary volume receives periodic updates from the primary volume so that it mirrors the contents of the primary volume.

FIGS. 1a and 1b generally illustrate one exemplary disk mirroring configuration. In FIGS. 1a and 1b the volume 6 and volume 8 can be in the same array, on different disk drives or on different arrays. As shown in FIGS. 1a and 1b, volume 6 and volume 8 are assumed to be on the same disk array.

Typically, a local host 2 instructs data storage on a local disk drive or drive array 6, also referred to as a local primary array or volume. During normal operation, data from the local primary volume 6 is mirrored or copied to the remote secondary volume 8 on a different disk drive of the same array in a known manner, by way of an internal link 10 connecting primary volume 6 with remote volume 8. The remote host 4 is in contact with the local host 2, and is also in contact with the remote volume 8.

As shown in FIG. 1b, however, problems typically occur when the internal link 10 connecting volumes 6,8 is out for some reason, for example, or if the internal link mirroring process is otherwise suspended or stopped for some reason as indicated by element 20 in FIG. 1b, for example. This results in an interruption of the mirroring process and may result in inconsistent data being stored on the volumes 6,8. Again, the suspension or stoppage of the mirroring process could occur for any number of reasons.

When these outages occur, existing mirroring software can report the outage by reporting the state of the disk drive or disk array or disk array pair. For exemplary purposes only, five general reportable categories of disk pair states may be as follows:

Connected—the disk arrays of the disk pair are in a connected state. Changes to the local volume or local disk array are being constantly sent to the remote or mirrored volume, or mirrored disk array. During this state, the local volume is host write enabled and the remote volume copy is in a host read-only state.

Resync—resynchronization is taking place (data is being copied out of order).

Suspended—pairing (mirroring) has been suspended. As of the moment of this suspended operation, data in both disk arrays is the same and both the local and remote volumes are host write enabled. The disk pair could be restored to a connected state by resynchronizing the data based on a divergence bitmap.

Error Suspended—pairing or mirroring is suspended due to a permanent error condition. Manual servicing by the administrator is typically done to return the disk pair to a known good state.

Deleted—the disks are in a deleted mode (not mirrored or paired). If the local and remote volumes were Suspended prior to the Delete operation, the contents of the local and remote volume will be identical.

If the mirroring process is suspended or stopped, the state of the storage device pair become data inconsistent between the two storage devices or disc arrays of the pair as soon as either the local or remote volumes are altered. The inconsistent state must be detected and the storage device pair must eventually be resynchronized in order to restore data consistency.

At the present time, in order to resynchronize the contents of the duplicate copy or secondary volume with those of the primary volume, a divergent bitmap table is used when the pair is suspended. The bitmap table identifies or points to, tracks of the primary volume that have changed so that when the pairs are resynchronized, only the changed tracks need be copied from the primary volume to the secondary volume. Currently, for the data to be backed up, the entire secondary volume must be copied to tape. If a recovery is required, the tape backup must be loaded to either the primary volume directly, or the secondary volume is restored and then copied back to the primary volume.

However, as reading from a tape drive is inherently slow, recovery of data from a tape backup drive can be time consuming. Further, the tape drive only marks a period in time at which synchronization was still present. Once a mirroring process suspension occurs, all data from the point in time indicated on the tape backup drive must be recovered and transferred to the secondary volume, or to the primary volume if this option is available.

### SUMMARY OF THE INVENTION

An apparatus, method computer readable medium and logical device have been created for storing essentially only modified or changed information from one of a pair of mirrored storage devices. For example, in one embodiment, essentially only changed tracks from a primary volume of a mirrored pair of mirrored storage units need be stored. By storing the tracks of actual information which was modified, a much smaller amount of actual information needs to be stored and retrieved in order to allow an older full copy backup to be brought current. In addition, it can be stored on the same storage unit as, or on a storage unit separate from, one or more of the primary and secondary volumes, and as such, recovery of information can occur much more quickly than that from a tape drive. Recovery can occur in either a forward or backward direction from the perspective of a particular full copy backup.

### BRIEF DESCRIPTION OF THE DRAWINGS

The invention will be explained in more detail below, by way of example with reference to exemplary embodiments as illustrated in the drawings, wherein:

FIG. 1a illustrates a generic disk mirroring configuration;

FIG. 1b illustrates one example where the disk mirroring configuration of FIG. 1a wherein the mirroring process has been suspended or stopped;

FIG. 2 illustrates generic primary and secondary volumes;

FIG. 3 illustrates an example of the differential or cumulative approach; and

FIG. 4 illustrates an example of the incremental approach.

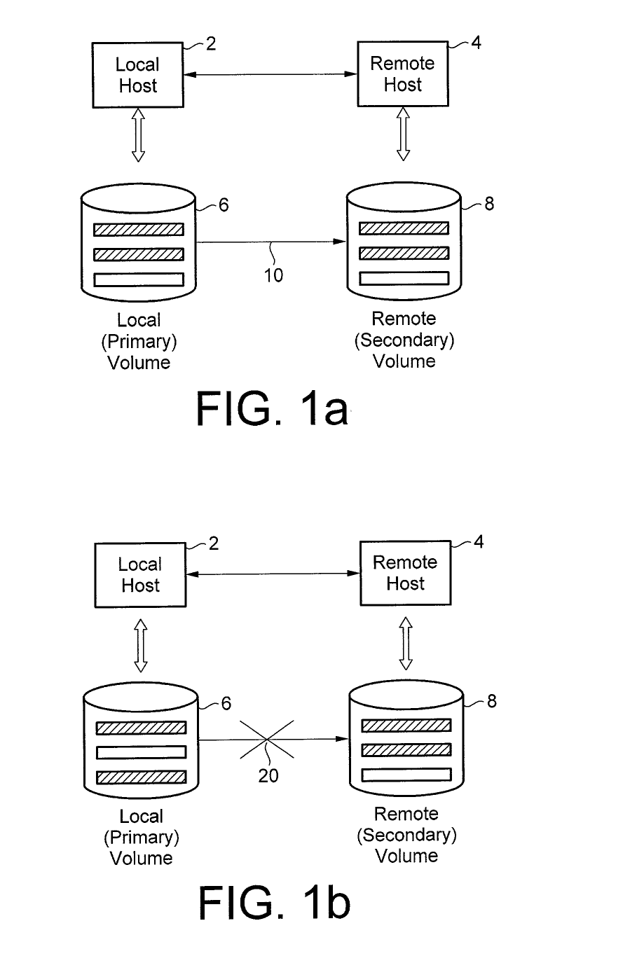

### DETAILED DESCRIPTION OF THE PREFERRED EMBODIMENTS

An apparatus, method, computer readable medium and logical device have been created for storing essentially only modified or changed information from one of a pair of mirrored storage devices. In one exemplary embodiment, essentially only tracks of information from a primary volume of a mirrored pair of mirrored storage units, which have been modified since a last command need be stored. By storing the tracks of actual information which was modified, a much smaller amount of actual information needs to be stored and retrieved in order to allow an older full copy backup to be brought current. In addition, such information can be stored on the same storage unit as, or on a storage unit separate from, one or more of the primary and secondary volumes. As such, recovery of information to a specific point in time can occur quickly. Only necessary information need be recovered; recovery can occur quickly; and/or recovery can occur in either a forward or backward direction relative to a full copy data backup.

Storage unit pairs can include paired disk drives on a common or separate disk array, paired disk arrays, etc., but may include any type of paired storage devices. Monitoring information, including, for example, at least one of information identifying the storage unit pair, information identifying associated mirroring software, information identifying a monitoring interval, etc., can be stored (or can be otherwise accessible, such as on a real time basis, for example) for at least one storage unit pair (including, a plurality of storage unit pairs). Based upon monitoring information for a particular storage unit pair (for example), the associated mirroring software can then be requested to obtain status information relating to the specified storage unit pair. Based upon the status information received, mirroring conditions of the storage unit pair are monitored to determine the status of a mirroring process between units of a specified storage unit pair. Alternatively or in addition thereto, status information can indicate whether or not the mirroring process between units of the storage unit pair has been suspended.

The method, apparatus, computer readable medium and logical device of various embodiments of the present application, include various ways of storing essentially only modified information (changed tracks for example) of a primary volume to reduce storage needs from those of storing all information in a primary or secondary volume for example. In addition, recovery can be expedited by permitting recovery based on easily accessible changed tracks of information, which can be quickly combined with a full copy for example, upon the mirroring process of a storage unit pair being resumed (after some sort of a suspension).

The apparatus preferably includes some kind of memory such as a disk, disk drive or disk array for example, adapted to store information obtained from one of a pair of mirrored storage devices, as well as some type of controller, adapted to control, e.g., by commanding, storage of information obtained from the one of the pair of mirrored storage devices during a suspended mirroring state of the mirrored pair, wherein the information obtained includes essentially only information in the one of the pair of storage devices which was modified since a last command. In one exemplary embodiment, the information obtained includes tracks of information, and the tracks of information include essentially only tracks of information in one of the pair of storage devices which were modified since a last command. Further, for recovery, the application of information can be commanded during a recognized suspended mirroring state of the mirrored pair, previously obtained from one of the pair of mirrored storage devices and stored in the memory, to the one of the pair of mirrored storage devices.

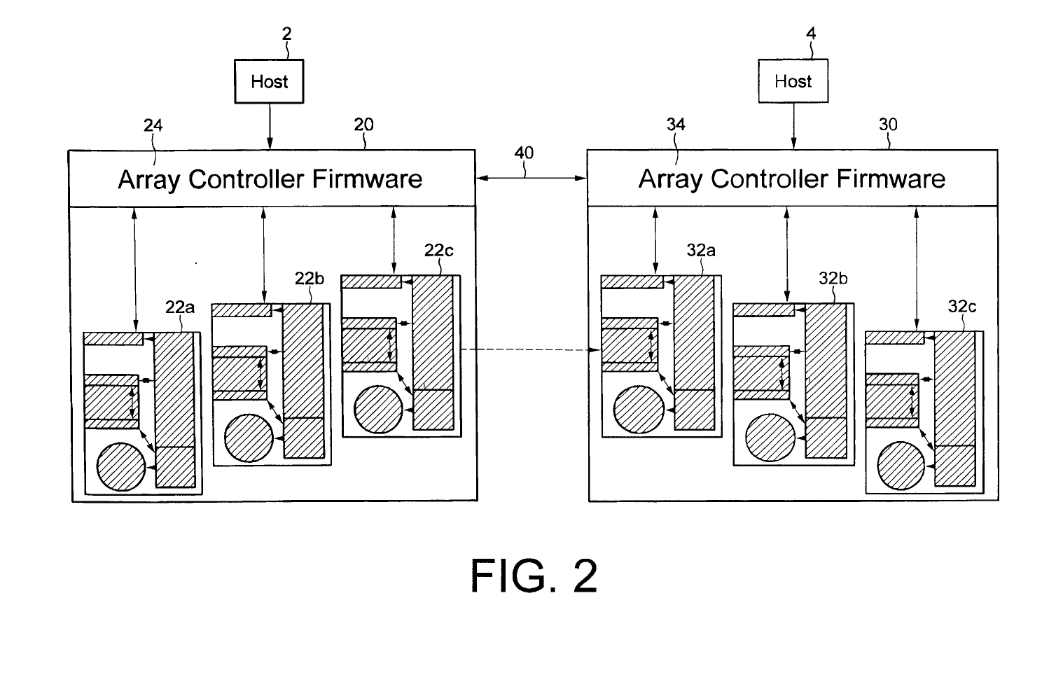

FIG. 2 of the present application is one exemplary apparatus used for disk array mirroring, which can also serve as an exemplary apparatus for carrying out the methodology of each embodiment of the present application. A primary volume 20 can be an aggregation of several disk drives 22A, 22B and 22C, sharing a common set of services, and can be in a common cabinet, for example. A single host 2 can control a plurality of disk drives of a single disk array 20, for example. The disk array 20 is exemplary of at least one of a primary and secondary volume, and of an apparatus for storing changed tracks or otherwise modified information of the present application, such as a TLS (Track Level Snapshot) device(s). It should be noted that one or more of the primary volume, secondary volume, and modified information storage apparatus of the present application can be included on the same disk array and/or separate disk arrays.

Array controller firmware 24 shown in FIG. 2 can be a layer of logic and control which can be inserted between the disk drives 22A, 22B, 22C and the host 2, and can include a logic array for example. The disk array 20 aggregates the various disk drives in a known manner to provide a larger pool of storage along with some data reliability services (for example, RAID (Redundant Arrays of Inexpensive Discs), mirroring, etc.). It should be noted that the block generically labeled “array controller firmware 24”, also may include cache memory, shared memory, disk controllers, a dedicated logical device, data/control buses, etc., not shown.

Although not shown in FIG. 2, a disk array 20 may have many ports (such as a fiber-channel port, an SCSI port, etc.), and may be connected to a plurality of different hosts. Disk arrays 20 are typically used by many different hosts (computers). Some hosts will share ports, but most hosts will talk using their own private ports, or private logical units (LUNs), which may or may not reside on a disk drive used by another host. LUNs are logical units/areas of storage area available within a disk array, and there are typically no restrictions on which host may read from or write to a given LUN, unless LUN security is being employed. LUNs are not physical things, but are abstractions created from the storage space available on a disk drive. Cache memory (also not shown in FIG. 2 for the sake of brevity), will typically serve as a high speed, semiconductor memory staging area for data. Read requests for data which have been recently read from a disk are called “read hits” and can be provided directly/quickly from a cache without a disk drive access operation. A read operation supplied from a cache is much faster than that of a normal disk read operation.

Since LUNs are virtual extractions, the pointers can sometimes be changed so that the same LUN number now points to a different physical disk (with the data automatically copied over). This feature, is sometimes used, for example, to speed up an application that was using slower disks when faster disks are available within the array. In any event, each of the these various aspects, although not shown or described in detail, can be used in storing information in a disk array 20.

Accordingly, FIG. 2 illustrates storage unit pair mirroring, an exemplary form of mirroring of a primary volume 20 and a secondary volume 30, wherein the mirror secondary volume similarly may include separate or common array controller firmware 34, separate or common disk drives 32A, 32B and 32C etc., and thus may house the logical device/modified information storage apparatus (including the TLS device(s)) of the present application. The remote or secondary volume 30 can be connected to a second host 4 in a manner somewhat similar to that previously described (or to the same host). For exemplary purposes only, it will be assumed that the configuration of FIG. 2 designates a single disk array (including both 20 and 30, which can be in a common cabinet, for example, and/or which can both be located on one or more of 20,30) housing the primary and secondary volumes and housing the TLS device(s) of the present application.

A typical mirrored write request involving both the primary volume 20 and the mirrored secondary volume 30 generally operates as follows. Initially, the write request arrives at volume 20 from host 2, and is placed in a request buffer. It may contain an identification of the requester, the location to be written, the length of the data, and the data itself, for example. The internal drive firmware 24 then examines the request. In addition to sending the immediate response back to the host 2 conveying “I finished your request”, and in addition to placing a write request on an internal “to do” I/O queue so that the data will eventually be written to a disk 22a, 22b, 22c of the primary volume array 20; the write request is also sent to the mirror volume 30 via the local link 40. The write request is the same as that provided by host 2. The primary volume 20 then waits for a reply and when received, the volume 30 treats the write request just like a normal write request from its host 4. At the time that the mirroring volume 30 is writing the mirrored request, however, its host 4 is only allowed to read all the disk drives in the mirrored state. Writes are only accepted from the dominant or primary volume 20.

As previously stated, in connection with disk array mirroring of a storage unit pair as shown in FIG. 2 for example, mirroring software currently exists which can report of the mirroring conditions of the storage unit pair. The mirroring software can report different mirroring states such as connecting, resync, suspended, error-suspend and deleted, for example.

According to one embodiment of the present invention, either a differential or cumulative approach can be used for storing modified information such as changed tracks of the primary volume either since the last resynchronization or since creation of the mirror, respectively. Since the mechanisms and methods involved in the cumulative approach are quite similar to the differential approach, the differential approach will only be described henceforth. In such an approach, during each update of the secondary volume such as during periodic updates for example, and/or at some designated time when the mirroring of the pair of mirrored storage devices is temporarily suspended, information which was modified since a last synchronization of the mirrored pair or since the creation of the mirrored pair is stored in memory in an accumulated manner. Such a memory can be part of an apparatus including a controller, such as a disk array for example, wherein the disk array may be one which is separate from and/or one which includes one or more of the primary and secondary volumes.

When information is initially stored on the primary volume, it changes data on specific tracks. When a track is changed, a bit can be changed in a bitmap to show that specific track had been changed. When a snapshot is requested in the differential or cumulative approach, the bitmap can be accessed and the related tracks to the changed bits can be stored to a track level device (TLD). Each time a differential snapshot is commanded (such as periodically, for example), all of the changes (changed tracks) e.g. since the last resynchronization, can be stored to a single TLD. This permits storage of essentially only changed tracks of the primary volume, for example, and the accumulation of track level snapshots permits a quick recovery of the secondary volume since only one instance of accumulated information (from the last resynchronization of one track level device (TLD)) need be applied to the primary volume during recovery thereof.

Further, as information is accumulated based upon a last synchronization of the storage units of the pair, for example, each accumulation can be easily tracked and marked based upon each resynchronization. Each resynchronization can result in a copying of all of the changed tracks, based on the bitmap information for example, to the secondary volume. The data on the primary and secondary volumes would then be the same (paired). The bitmap is not required while the primary and secondary volumes are “paired”, since the updates to the primary volume are also being done to the secondary volume. When the volumes are suspended, then a bit in the bitmap can be changed for each track which has been updated. Each accumulation forms a complete set of the changed tracks since the last resynchronization, as a single TLD.

Each update may be commanded periodically and stored in a cumulative manner, as a single track level snapshot (TLS) in a track level device (TLD), for example. The TLD may be a special type of disk array LUN, for example, including a controller and memory which may or may not be separate from one which includes one or more of the primary and secondary volumes. Initially, in response to splitting and recognizing a split of a storage unit pair into a suspended state, or otherwise recognizing that the storage unit pair is in a suspended state (which can occur at any defined and/or periodic times including, but not limited to the times when the secondary volume typically receives updates from the primary volume), essentially only information in the primary volume which was modified since a last command is stored, for example as a TLS. The command can be one which is given periodically, for example, such as when the secondary volume is typically updated, wherein the modified information obtained at each command, is stored in an accumulated manner until a next synchronization of the mirrored pair.

In the differential, or cumulative since the last resynchronization, approach, all of the changed tracks since the last synchronization of the original mirror can be stored. This permits performance of a full restore very quickly since only one TLS Device would need to be applied to get the primary volume back to a specific time. One exemplary way to implement the differential embodiment would be to develop and use additional commands which can be stored in software and executed by a computer processor and sent to the array, or even implemented in firmware. Thus, if stored in firmware, such as in a logical device for example, the logical device could be operable to perform the various method or program command steps. The additional commands can include:

Paircreate -g groupname—TLS

Create the secondary volume (S-Vol) from the primary volume (P-Vol);

Allocate bitmaps for the P-Vol and the S-Vol;

Allocate a third bitmap for TLS processing.

Pairsplit -g groupname

Split pair into suspended state if not already in a suspended state;

Getbitmap -diff

Allocate the TLD, if one isn't already allocated

Clear the contents of the TLD

Store the bitmap table to the TLD for recovery purposes

Write the changed tracks from the P-Vol to the TLD

Pairresync -g groupname

Copy the changed tracks from the P-Vol to the S-Vol Clear all bitmaps

Release the TLD

Pairresync -g groupname—TLS

Restore the changed tracks on the TLD to the P-Vol;

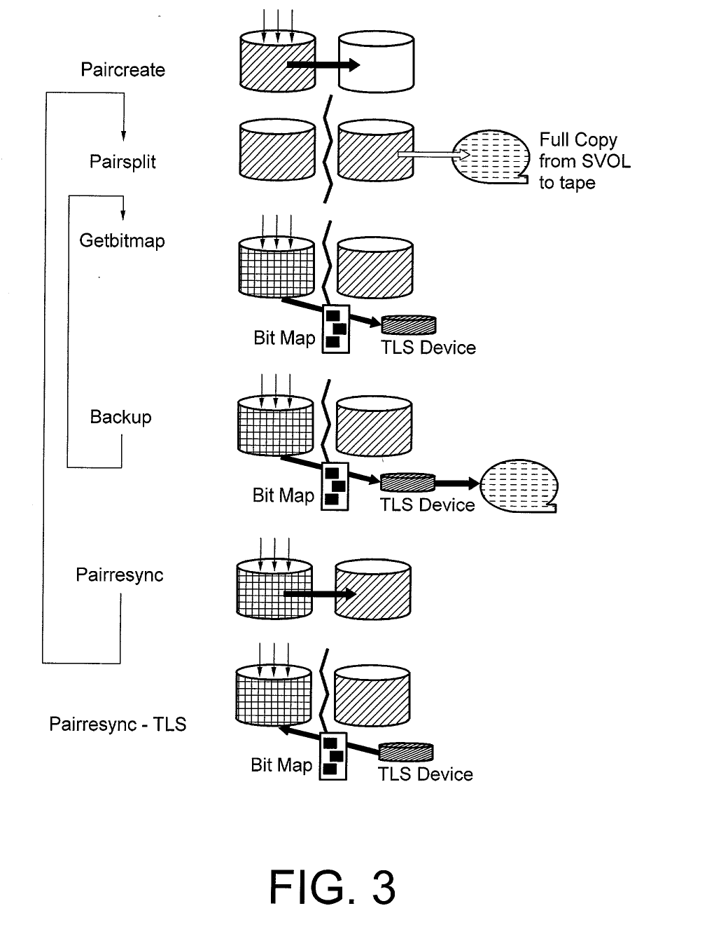

FIG. 3 provides one example illustrating the differential, or cumulative since the last resynchronization, approach. In this example, the “paircreate” command can be called at some time to initially create a secondary volume from the primary volume for mirroring purposes. If necessary, a “pairsplit” command can be called to split the mirroring pair into a suspended state, if not already in a suspended state. At this time, a full copy of all tracks of the secondary volume may be stored on tape.

Once it is recognized that the pair of storage devices are in a suspended mirroring state, the “getbitmap” command can be called. At this time, a TLS device can be allocated (some space in memory of the TLD is allocated and identified), contents of the TLS device can be cleared, and a bitmap table for the primary volume can be obtained and stored for later recovery, if necessary. The changed tracks of the primary volume can then be written to the TLS device. A “backup” command can be called, and a backup application can then be used to copy the contents of the TLS device to offline storage, if desired. Thereafter, during periodic or other designated time periods, changed tracks of the primary volume can be written to the TLS device, accumulated with previously written changes. As such, a TLS device storing changed tracks since a last synchronization of the storage device pair, is created. Further, in this accumulated approach, since the bitmap may not be cleared after every snapshot, all changes since the last resynchronization can be recorded in the bitmap.

In order to resynchronize the storage device pair using the created TLS device, a “pairresync” command can be called. If there are no problems and this is a normal resynchronization of the pair, then tracks are copied from the primary volume to the secondary volume, bitmaps are cleared, and the TLS device can be released. This can done by calling the “pairresync -g groupname” command, for example. However, if the TLS device is to be used, the “pairresync -g groupname—TLS” command can be called, and the changed tracks can then be written from the TLS device to the primary volume in a fast and efficient manner. The two bitmaps may be used to allow the primary volume to be updated while the snapshot or the changed tracks are copied to the TLS Device. For example, if additional tracks are being changed on the primary volume, the new changed tracks may not be captured in the TLS bitmap, but may only be captured in the primary volume bitmap.

In another embodiment, the modified information such as the changed tracks, can be stored incrementally. Such an embodiment operates essentially the same as the cumulative embodiment indicated above except that, at each command for example, the information obtained for the primary volume can be separately stored in this incremental approach, as separate TLS(s) in a single apparatus (e.g. single disk array 20), for example. The information obtained can include essentially only information modified since the last TLS was stored. Thus, for example, the information can include essentially only tracks of the primary volume that were changed since the last TLS was stored. This would require storage of a relatively small amount of data for each TLS, but might slightly increase the recovery time needed to perform a restore as compared to the previous cumulative embodiment, since multiple TLS devices will need to be called.

In this incremental embodiment, additional commands can again be stored in software and executed (potentially periodically) by a computer processor within the array or sent to the array, or even implemented in firmware within the array. Thus, if stored in firmware, such as in a logical device for example, the logical device could be operable to perform the various method or program command steps. The additional commands can include:

paircreate -g groupname—TLS

Create the secondary volume (S-Vol) from the primary volume (P-Vol);

Allocate bitmaps for the P-Vol and the S-Vol;

Allocate a third bitmap for TLS processing

pairsplit -g groupname

split a pair into suspend state if not already in a suspended state;

getbitmap

Allocate a new TLS Device

Store the bitmap table to the TLS Device for recovery purposes

Store a sequence number on the TLS Device

Write the changed tracks from the P-Vol to the TLS Device

Pairresync -g groupname

Copy the changed tracks from the P-Vol to the S-Vol

Clear all of the bitmaps

Release all the TLS Devices

pairresync -g groupname—TLS

Restore the changed tracks from the latest TLS device to the primary volume;

pairresync -g groupname—TLSall

Restore the changed tracks from all of the TLS Device(s) (in order) to the P-Vol;

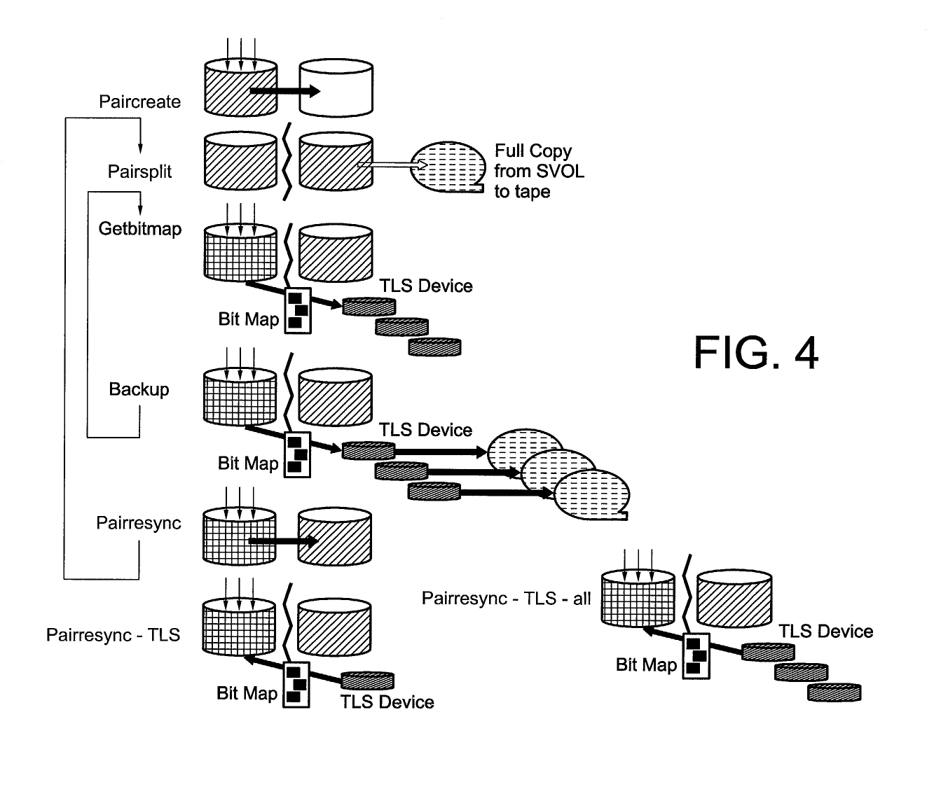

FIG. 4 provides one example illustrating the incremental approach. In this example, the “paircreate” command can be called at some time to initially create a secondary volume from the primary volume for mirroring purposes. If necessary, a “pairsplit” command can be called to split the mirroring pair into a suspended state, if not already in a suspended state. At this time, a full copy of all tracks of the secondary volume may be stored on tape.

Once it is recognized that the pair of storage devices are in a suspended mirroring state, the “getbitmap” command can be called. At this time, a TLS device can be allocated (some space in memory of the TLD is allocated and identified), contents of the TLS device can be cleared, and a bitmap table for the primary volume can be obtained and stored for later recovery, if necessary. A sequence number, for example, can then be allocated and stored to identify the TLS device. The changed tracks of the primary volume are then be written to the TLS device. A “backup” command can be called, and a backup application can then be used to copy the contents of the TLS device to offline storage, if desired. Thereafter, during periodic or other designated time periods, tracks of the primary volume that have changed since the last TLS device was created, can be written to a new TLS device, with other TLS device(s) separately storing previously written changes. As such, multiple TLS devices storing incrementally changed tracks of the primary volume since a last synchronization of the storage device pair, are created. Further, in this incremental approach, the bitmap may be cleared after every snapshot, and all new changes since the last snapshot may then be recorded in the bitmap.

In order to resynchronize the storage device pair using the created TLS devices, a “pairresync” command can be called. If there are no problems and this is a normal resynchronization of the pair, then tracks are copied from the primary volume to the secondary volume, bitmaps are cleared, and all of the TLS devices can be released. This is done by calling the “pairresync -g groupname” command, for example. However, if the TLS devices are to be used, the “pairresync -g groupname—TLS” command can be called, and the changed tracks can then be written from the latest TLS device to the primary volume; or a “pairresync -g groupname TLSall” command can be called, and the changed tracks can then be written from all the TLS devices, in sequence based upon the stored sequence numbers, to the primary volume. The two bitmaps may be used to allow the primary volume to be updated while the snapshot or the changed tracks are copied to the TLS Device. For example, if additional tracks are being changed on the primary volume, the new changed tracks may not be captured in the TLS bitmap, but may only be captured in the primary volume bitmap.

Thus, in either embodiment, the method can include recognizing a suspended mirroring state of a pair of mirrored storage devices, and commanding storage of information obtained from one of the pair of mirrored storage devices in a memory, during a recognized suspended mirroring state of the mirrored pair, wherein the information obtained can include essentially only information in the one of the pair of storage devices which was modified since a last command. In one exemplary embodiment, the information obtained can include tracks of information, and the tracks of information can include essentially only tracks of information in one of the pair of storage devices which were modified since a last command. The methodology can be stored in an apparatus or a logical device, operable to perform the methodology.

Further, for recovery, the application of information can be commanded during a recognized suspended mirroring state of the mirrored pair, previously obtained from one of the pair of mirrored storage devices and stored in the memory, to the one of the pair of mirrored storage devices. This can apply to both the differential/cumulative embodiment, and to the incremental embodiment. In addition, such information can be stored on the same storage unit as, or on a storage unit separate from, one or more of the primary and secondary volumes. As such, recovery of information can occur quickly. Only necessary information need be recovered; recovery from a disk drive, for example, can occur quickly; and/or recovery can occur in either a forward or backward direction.

Since all of the changed tracks from the primary volume can be recorded in the bitmap, those tracks are written to a TLD as an “after image”. The same corresponding tracks from the secondary volume can be written to another TLD as a “before image”. Depending on the point-in-time to be restored, the “before image” or “after image” can be used to permit recovery in either the forward or backward direction (i.e. in whichever direction that would lead to a relatively quicker recovery).

The apparatus, method, etc. of the present application can be customized to work with any type of mirroring software for any type of paired storage devices and thus the mirroring software is only described at the conceptual level, for the sake of clarity and brevity. The concepts described herein can be adapted to any particular mirroring software being utilized, wherein stored monitoring information for a particular storage unit pair can indicate the particular mirroring software associated therewith.

Further, the methodology of either of the differential/cumulative or incremental embodiments can be embodied on a computer-readable medium. Such a computer readable medium can include code portions embodied thereon that, when read by a processor, cause the processor to perform the methodology of either embodiment as previously described above.

Referring back to FIG. 2, a first primary volume 20 is illustrated, connected to a secondary volume 30. Again, it should be noted that the primary and secondary volumes may be part of the same or different disk arrays and the apparatus (including the TLD and TLS device(s)) for storing modified information may be part of a separate disk array, or a disk array common with one or more of the disk arrays of the primary volume 20 and of the secondary volume 30. The primary volume 20 and the mirrored secondary volume 30 may be connected via an internal link 40, if part of the same disk array or a private optical link if part of different disk arrays, for example. The two volumes 20 and 30 form a storage unit/device pair, and need not be located physically close to one another. Disk arrays can mirror one another and can mirror LUNs, across a great distance, such as several kilometers, for example. In addition, some or all disks of a disk array may be part of a mirrored pair. Thus, for the purpose of the present application, a storage unit pair can include any pair of storage devices including but not limited to a primary and a mirror secondary disk pair within the same array for example, a primary array 20 and a mirror array 30 for example, etc.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An apparatus, comprising:
a memory, adapted to store information obtained from one of a pair of mirrored storage devices; and
a controller, adapted to control storage of information obtained from the one of the pair of mirrored storage devices during a suspended mirroring state of the mirrored pair, wherein the information obtained includes essentially only information in the one of the pair of storage devices which was modified since a last command.

2. The apparatus of claim 1, wherein the information obtained includes tracks of information, and wherein the tracks of information include essentially only tracks of information in one of the pair of storage devices which were modified since a last command.

3. The apparatus of claim 1, wherein the memory is a disk array.

4. The apparatus of claim 1, wherein the pair of mirrored storage devices include a pair of mirrored disk arrays.

5. The apparatus of claim 1, wherein the memory is a disk array, and wherein the disk array includes at least one of the pair of mirrored storage devices.

6. The apparatus of claim 1, wherein the memory is adapted to separately store obtained information in response to each command.

7. The apparatus of claim 1, wherein the commands are periodic.

8. The apparatus of claim 6, wherein each separate storage of obtained information is stored in association with an identifier.

9. The apparatus of claim 8, wherein identifiers indicate a separate storage sequence.

10. The apparatus of claim 1, wherein the apparatus is a disk array.

11. The apparatus of claim 1, wherein a mirrored storage device pair is at least one of manually and automatically suspendable.

12. The apparatus of claim 6, wherein each separate storage includes only information which is different from a previous separate storage.

13. The apparatus of claim 1, wherein the memory is adapted to store information accumulated either since a previous synchronization of the mirrored pair or since the creation of the mirrored pair.

14. The apparatus of claim 1, wherein the controller is adapted to provide periodic commands.

15. The apparatus of claim 2, wherein the controller is adapted to provide periodic commands.

16. The apparatus of claim 1, wherein, for recovery, the controller is adapted to command application of the information during a recognized suspended mirroring state of the mirrored pair, previously obtained from one of the pair of mirrored storage devices and stored in the memory, to the one of the pair of mirrored storage devices.

17. The apparatus of claim 1, wherein the controller is adapted to control the storage of information by commanding the storage, of the information obtained from the one of the pair of mirrored storage devices during a suspended mirroring state of the mirrored pair, to occur.

18. A method comprising:
recognizing a suspended mirroring state of a pair of mirrored storage devices; and
controlling storage of information obtained from one of the pair of mirrored storage devices in a memory, during a recognized suspended mirroring state of the mirrored pair, wherein the information obtained includes essentially only information in the one of the pair of storage devices which was modified since a last command.

19. The method of claim 18, wherein the information obtained includes tracks of information, and the tracks of information include essentially only tracks of information in one of the pair of storage devices which were modified since a last command.

20. A logical device, operable to perform the method of claim 18.

21. A logical device, operable to perform the method of claim 19.

22. The method of claim 18, wherein the memory is a disk array.

23. The method of claim 18, wherein the pair of mirrored storage devices include a pair of mirrored disk arrays.

24. The method of claim 18, wherein the memory is a disk array, and wherein the disk array includes at least one of the pair of mirrored storage devices.

25. The method of claim 18, wherein the memory is commanded to separately store obtained information in response to each command.

26. The method of claim 25, wherein the commands are periodic.

27. The method of claim 25, wherein each separate storage of obtained information is stored in association with an identifier.

28. The method of claim 27, wherein an identifier indicates a separate storage sequence.

29. The method of claim 17, wherein a mirrored storage device pair is at least one of manually and automatically suspendable.

30. The method of claim 24, wherein each separate storage includes only information which is different from a previous separate storage.

31. The method of claim 18, wherein the memory is commanded to store information accumulated either since a previous synchronization of the mirrored pair or since the creation of the pair.

32. The method of claim 18, wherein the commands are periodic, and wherein the memory is commanded to store obtained information from each command in an accumulated manner with previously obtained information.

33. The method of claim 18, wherein the commands are provided periodically.

34. The method of claim 18, further comprising:
commanding application of information during a recognized suspended mirroring state of the mirrored pair, previously obtained from one of the pair of mirrored storage devices and stored in the memory, to the one of the pair of mirrored storage devices.

35. A logical device, operable to perform the method of claim 34.

36. The method of claim 34, wherein the application commands are periodic.

37. The method of claim 34, wherein the memory is commanded to separately store obtained information in response to each command, and wherein sequential application of the separately stored information is commanded.

38. The method of claim 34, wherein the memory is commanded to store information accumulated since a previous synchronization of the mirrored pair, and wherein application of the accumulated information is commanded.

39. The method of claim 34, wherein the commands are periodic, wherein the memory is commanded to store obtained information from each command in an accumulated manner with previously obtained information, and wherein application of the accumulated information is commanded.

40. The method of claim 18, wherein the step of controlling controls the storage of information by commanding the storage, of the information obtained from the one of the pair of mirrored storage devices during a suspended mirroring state of the mirrored pair, to occur.

41. An apparatus comprising:
a unit to recognize a suspended mirroring state of a pair of mirrored storage devices; and
a control unit to control storage of information obtained from one of the pair of mirrored storage devices in a memory, during a recognized suspended mirroring state of the mirrored pair, wherein the information obtained includes essentially only information in the one of the pair of storage devices which was modified since a last command.

42. The apparatus of claim 41, wherein the information obtained includes tracks of information, and the tracks of information include essentially only tracks of information in one of the pair of storage devices which were modified since a last command.

43. The apparatus of claim 41, wherein the controller is adapted to control the storage of information by commanding the storage, of the information obtained from the one of the pair of mirrored storage devices during a suspended mirroring state of the mirrored pair, to occur.

44. A computer-readable medium having code portions embodied thereon that, when read by a processor, cause said processor to perform the method of claim 18.

45. A computer-readable medium having code portions embodied thereon that, when read by a processor, cause said processor to perform the method of claim 34.
